(19) United States
(12) Patent Application Publication
(10) Pub. No.: US 2026/0094431 A1
(43) Pub. Date: Apr. 2, 2026

(54) SHARE SENSOR DATA FEATURE VECTORS

(71) Applicant: ObjectVideo Labs, LLC, Tysons, VA (US)

(72) Inventor: Ariel Amato, Barcelona (ES)

(21) Appl. No.: 19/332,814

(22) Filed: Sep. 18, 2025

Related U.S. Application Data
(60) Provisional application No. 63/700,805, filed on Sep. 30, 2024.

(51) Int. Cl. G06V 10/96; G06V 10/80; G06V 10/82

(52) U.S. Cl. CPC G06V 10/96; G06V 10/806; G06V 10/82

(57) ABSTRACT

Methods, systems, and apparatus, including computer programs encoded on computer storage media, for sharing sensor data feature vectors. One of the methods includes detecting, by a device at a property, an object of interest; determining, by the device, whether a first feature vector that likely represents the object of interest and was received from a different device is available; in response to determining that the first feature vector that likely represents the object of interest and was received from the different device is available, obtaining, by the device, the first feature vector that likely represents the object of interest and was received from the different device; performing, by the device, an analysis task for the object of interest at least using the first feature vector that likely represents the object of interest and was received from the different device; and performing an action using a result of the analysis task.

### CROSS-REFERENCE TO RELATED APPLICATION

This application claims the benefit of U.S. Provisional Application No. 63/700,805, filed September 30, 2024, and titled “Share Sensor Data Feature Vectors,” which is incorporated by reference.

### BACKGROUND

Visual recognition involves processing images, videos, or both, and performing visual recognition tasks, such as object classification, object detection (e.g., person, animal, vehicle, or face detection), and object segmentation (e.g., panoptic segmentation, semantic segmentation). The visual recognition tasks can be performed through an artificial intelligence model. For example, the visual recognition tasks can be performed through a visual recognition machine learning model, e.g., a neural network model.

Neural networks are machine learning models that employ multiple layers of operations to predict one or more outputs from one or more inputs. Neural networks typically include one or more hidden layers situated between an input layer and an output layer. The output of each hidden or input layer is used as input to another layer in the neural network, e.g., the next hidden layer or the output layer.

A feature vector is a multi-dimensional numerical representation that can be extracted from one or more specific layers of a neural network. In vision-based deep neural networks, the feature vectors typically capture characteristics of a scene or an object. The level of detail in the information that the feature vectors represent can vary depending on the layer from which they are extracted, with shallower layers capturing more local features and deeper layers capturing more global features. Feature vectors can organize an object's attributes into a structured format, such as a vector or a matrix, allowing artificial intelligence algorithms to efficiently process the data and learn patterns.

### SUMMARY

Given limited input data, hardware capability, or both, devices that perform artificial intelligence operations, e.g., neural network operations, are limited in the accuracy of output data they generate. This can occur because a device has limited storage or computing power for the large amount of neural network operations for the artificial intelligence models.

To improve the accuracy of a device, a group of devices can share feature vectors for potential objects of interest. For example, the feature vectors can represent pre-processed information for the potential objects of interest. When a device detects a potential object of interest, the device can determine whether any other feature vectors are available that likely represent the object of interest. These other feature vectors can be passively received by the device from other devices, e.g., at the same property, can be actively retrieved by the device from the other devices, or a combination of both.

The device can generate its own feature vector for the potential object of interest, e.g., using sensor data captured by a sensor included in or coupled to the device. The device can use its own feature vector with the other feature vectors from the other devices during inference to determine whether the potential object of interest is an actual object of interest. By using multiple feature vectors for the potential object of interest, the device can more accurately perform an analysis task, such as a visual recognition task. For example, by using multiple feature vectors for the potential object of interest, the device can more accurately predict whether the object is an actual object of interest because the other feature vectors can include features of the object not included in or otherwise represented by the device’s own feature vector, enabling the device to use a more robust input data set during inference.

In general, one innovative aspect of the subject matter described in this specification can be embodied in methods that include the actions of: detecting, by a device at a property, an object of interest; determining, by the device, whether a first feature vector that likely represents the object of interest and was received from a different device is available; in response to determining that the first feature vector that likely represents the object of interest and was received from the different device is available, obtaining, by the device, the first feature vector that likely represents the object of interest and was received from the different device; performing, by the device, an analysis task for the object of interest at least using the first feature vector that likely represents the object of interest and was received from the different device; and performing, by the device, an action using a result of the analysis task.

Oher implementations of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination. The actions can include generating, by the device, a second feature vector for the object of interest using sensor data captured by a sensor coupled to the device, wherein performing the analysis task for the object of interest uses: (i) the second feature vector for the object of interest generated using the sensor data captured by the sensor coupled to the device; and (ii) the first feature vector that likely represents the object of interest and was received from the different device. Performing the analysis task for the object of interest uses a combined feature vector generated using the first feature vector and the second feature vector. Performing the analysis task for the object of interest includes: sequentially providing the first feature vector and the second feature vector as input to an artificial intelligence model to cause the artificial intelligence model to a) store in memory an intermediate value generated from a first input, and use the intermediate value to process a second input and b) generate an output for the analysis task; and obtaining the output for the analysis task after the artificial intelligence model processes all of the input. The first feature vector and the second feature vector represent the object of interest from different perspectives. Performing the analysis task for the object of interest includes: processing the first feature vector and the second feature vector using an artificial intelligence model trained to determine whether the first feature vector and the second feature vector likely represent a same object; and obtaining the result of the analysis task indicating whether the first feature vector and the second feature vector likely represent the same object. The actions include receiving the first feature vector in response to a detection of an event by the different device. The actions include in response to the device detecting an event, requesting the first feature vector; and in response to requesting the first feature vector, receiving the first feature vector. Performing, by the device, the action using the result of the analysis task includes: determining, by the device, that the result of the analysis task is likely related to a monitoring system action; and in response to determining that the result of the analysis task is likely related to the monitoring system action, sending, by the device, the result of the analysis task to a monitoring system. Performing, by the device, the action using the result of the analysis task includes: determining, by the device, that the result of the analysis task is not likely related to a monitoring system action; and in response to determining that the result of the analysis task is not likely related to the monitoring system action, deleting, by the device, the first feature vector from a memory of the device.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform those operations or actions. That one or more computer programs is configured to perform particular operations or actions means that the one or more programs include instructions that, when executed by data processing apparatus, cause the apparatus to perform those operations or actions. That special-purpose logic circuitry is configured to perform particular operations or actions means that the circuitry has electronic logic that performs those operations or actions.

The subject matter described in this specification can be implemented in various implementations and may result in one or more of the following advantages. In some implementations, the systems and methods can reduce the required storage, computing power, or both, of the devices because the devices can reuse feature vectors of objects previously generated at one or more other devices. In some implementations, using the systems and methods described in this specification, resource-constrained devices such as edge computing devices can perform complex artificial intelligence tasks locally, improving decision-making speed, enhancing privacy and security, or a combination of both. In some implementations, the systems and methods described in this specification can improve the accuracy of an analysis result by using multiple feature vectors that represent different perspectives of the object of interest. For example, multiple feature vectors generated from different images can represent attributes of an object with and without occlusions, enhancing the accuracy of the analysis result. In some implementations, the systems and methods can leverage computational power of multiple devices for in-depth analysis, e.g., enabling greater accuracy, computational processing that might be otherwise unavailable, or both. For example, information pre-processed by the first device can be shared as feature vectors to the second device for further processing. In some cases, the feature vectors can be combined with data obtained from the second device for further processing. In some cases, the second device can provide a deeper analysis starting from the feature vectors of the first device.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram illustrating an example environment with a property monitoring system.

FIG. 2 is a flow diagram of a process for the property monitoring system.

FIG. 3 is a diagram illustrating an example of a property monitoring system.

Like reference numbers and designations in the various drawings indicate like elements.

### DETAILED DESCRIPTION

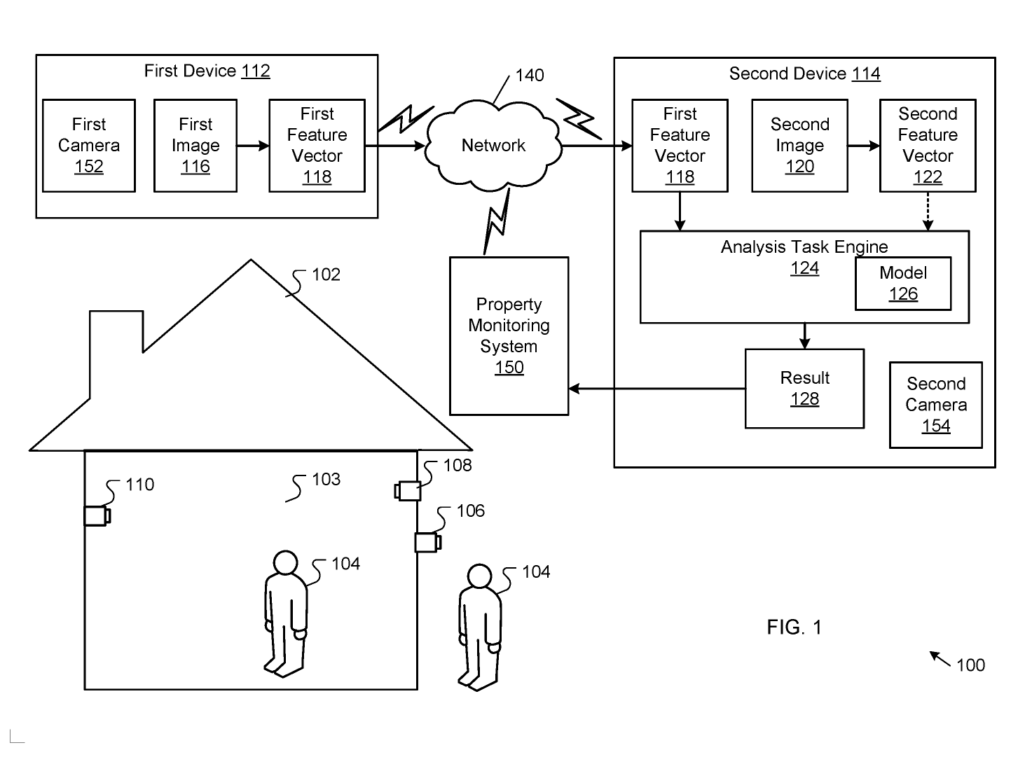

FIG. 1 is a diagram illustrating an example environment 100 with a property monitoring system 150. The property monitoring system 150 includes one or more sensors that monitor a property 102. The one or more sensors can include two or more cameras 106, 108, and 110, an audio sensor, e.g., a microphone, a temperature sensor, a humidity sensor, an air flow sensor, a motion sensor, a wireless network sensor, a robot, or a combination of these. The property 102 can be a residential property or a commercial property.

Each sensor can generate sensor data that represents an object of interest inside or around the property 102 that is being monitored by the sensor. An object of interest can include a person, a pet, a vehicle, or a weapon. In some cases, an event happening at the property and being monitored by the property monitoring system 150 can be related to an object. The sensor data can include data captured by a sensor included in the property monitoring system 150.

For example, a first camera 152 can generate camera data, e.g., an input image 116 or a video. The input image 116 or video can be a color image or video, grayscale image or video, or both. The input image 116 or video can depict an object of interest inside or around a property that is being monitored by the camera 152. For example, a front door camera 106 can capture an image of a person 104 near the front door of a residence, and the image can depict a person who is near the front door. A living room camera 108 can capture an image of a person who is in the living room 103.

The property monitoring system 150 includes two or more devices 112 and 114. Each device can be coupled to a sensor. In some implementations, the sensor can be included in the device. In some implementations, the sensor can be connected to the device over a network 140. For example, the first device 112 can be coupled to the first camera 152, e.g., a front door camera 106. The second device 114 can be coupled to the second camera 154, e.g., a living room camera 108. Although this specification describes additional features with respect to the second device 114, the first device 112 can similarly implement one or more of those features, e.g., the analysis task engine 124 including the model 126.

In some implementations, the device can be an edge computing device. Edge computing processes data closer to its source, reducing latency and bandwidth, and improves data security and privacy. For example, the device 112 can be located at or near the camera 152 of the property monitoring system 150. After capturing an image, the device 112 coupled to the camera 152 can process the image, without a need to send the image to a remote system, e.g., a server, for visual recognition analysis processing.

The property monitoring system 150 can perform an analysis task on the one or more devices using an artificial intelligence model. Each device can perform an analysis task, e.g., a visual recognition task, using sensor data captured by the sensor coupled to the device. For example, the property monitoring system 150 can perform a visual recognition task on the second device 114 using an analysis task engine 124 that implements a, e.g., visual recognition, machine learning model 126. Examples of visual recognition tasks include object classification, object detection, and object segmentation, or a combination of these.

Although some examples refer specifically to machine learning models, similar examples also apply to other types of artificial intelligence models. Performing an inference of a visual recognition machine learning model using image or video obtained from cameras are one of the applications that the described systems and techniques are applicable. The systems and techniques described in this specification can be applied to other types of machine learning models that process other types of sensor data, e.g., any other type of sensor mentioned here, and for other types of tasks, e.g., voice recognition tasks, motion recognition tasks, event recognition, or a combination of these.

The device 114 is a computing device that includes inference hardware optimized for machine learning tasks. For example, the device 114 can include an artificial intelligence card, one or more graphics processing units (GPUs), one or more tensor processing units (TPUs), one or more central processing units (CPUs), some other appropriate type of hardware, or a combination of these.

A machine learning model can be a neural network model that is configured to perform multiple operations, e.g., one set of operations for each layer in the neural network model, to predict one or more outputs from one or more inputs. Neural networks typically include one or more hidden layers situated between an input layer and an output layer. The output of each input or hidden layer is used as input to another layer in the neural network, e.g., the next hidden layer or the output layer. Machine learning models that require high accuracy, e.g., machine learning models for video surveillance and video understanding, can be deep neural networks that include tens or hundreds of layers, with thousands or millions of parameters for the layers. These sophisticated machine learning models demand increased computational resources, posing a significant challenge for deployment on an inference device, especially for resource-constraint devices, such as edge computing devices.

A feature vector is a multi-dimensional vector of, e.g., numerical, features that represent an object. A feature vector can be an output generated from a machine learning at an output layer or at an intermediate layer. The feature vector can capture essential characteristics of the object. A feature vector organizes multiple features of an object into a specific format (e.g., a vector format or a matrix format), allowing machine learning algorithms to efficiently process data and learn patterns. For example, a deep neural network model can generate a feature vector of length A or a feature matrix of size AxA, for an input image. In some implementations, the feature vector can include a feature matrix. The feature matrix can be a two-dimensional matrix, a three-dimensional matrix, or a high dimensional matrix with a dimension that is larger than one.

Two or more devices in the property monitoring system 150 can share feature vectors for potential objects of interest. In some implementations, the first device 112 and the second device 114 can share the first feature vector 118 for an object of interest. The first device 112 can generate the first feature vector 118 using an artificial intelligence model. The artificial intelligence model can be a machine learning model or another appropriate type of artificial intelligence model. The artificial intelligence model can be a separate model, or the same model, as the model 126, described in more detail below. The artificial intelligence model can process the first image 116 to generate the first feature vector 118. In some implementations, the first image 116 can be obtained from the first camera 152 associated with the first device. In some implementations, the first image 116 can be obtained from a different device of the property monitoring system 150. In some implementations, the first image 116 can include an image frame extracted from a video captured by the first camera 152. In some implementations, the artificial intelligence model can process a video or one or more frames of a video to generate the first feature vector 118.

For example, the first device 112 can be coupled to the front door camera 106. When the person 104 arrives at the front door of the property 102, the camera 106 can obtain an image 116 of the face of the person 104. The first device 112 can generate a feature vector 118 of the person 104 using a machine learning model. For example, the first device 112 can process the first image 116 using a feature extraction neural network trained to extract facial features from the face image of the person and can generate a first feature vector 118 that represents the facial features of the person 104. The feature extraction neural network can include an input layer that processes an input image or video, multiple intermediate layers (e.g., convolutional layers), and an output layer (e.g., a fully connected layer) that generates the feature vector 118.

When a device detects a potential object of interest, the device can determine whether any other feature vectors are available that likely represent the object of interest. For example, when the person 104 enters the living room 103, the second device can detect the person 104 and the second device 114 can determine whether any other feature vectors are available that likely represent the object of interest. The second device 114 can be coupled to the living room camera 108 that captures an image of the person 104. The second device can process the image to determine that a person, as one type of an object of interest, is detected in the living room. After detecting the person, the second device 114 can determine whether any feature vectors of the person 104 are available that likely represent the person 104.

If the device determines that one or more other feature vectors that likely represent the object of interest are available, the device can obtain the one or more other feature vectors that likely represent the object of interest. For example, second device 114 can determine that the first feature vector 118 that likely represents the person 104 is available. The second device can obtain the first feature vector 118 over the network 140 that connects the first device 112 and the second device 114, from memory, e.g., included in the second device 114, or from another appropriate source.

In some implementations, the device can passively receive the one or more other features vectors from one or more other devices, e.g., at the same property. For example, after generating the first feature vector 118, the first device 112 can predict that the person 104 might enter the living room 103 and the second device 114 coupled to the living room camera 108 might need to perform an analysis task associated with the person 104. Thus, the first device 112 can send the first feature vector 118 of the person 104 to the second device 114, and the second device 114 can passively receive the first feature vector 118 of the person 104. In some cases, the first device 112 might not have a machine learning model for an analysis task, and the first device can send the feature vector 118 to the second device 114 that includes an analysis task engine 124 that can perform the analysis task using a machine learning model 126.

In some implementations, the device can actively retrieve the one or more other feature vectors from one or more other devices. For example, after detecting the person 104, the second device 114 can send a request to the first device 112 to retrieve the first feature vector 118 of the person 104 from the first device 112. The second device 114 can select other devices to which to send the request. The second device can select a third device using the distance between the devices. For example, the second device can select the third device if the second device and the third device satisfies a distance threshold, a room adjacency threshold, or both. The second device can send the request to retrieve the first feature vector to the selected third device.

In some implementations, if the device determines that other feature vectors that likely represent the object of interest are not available, the device can process data for the detected object as the device would normally, e.g., without shared feature vectors. For instance, the device can generate a feature vector of the object of interest using sensor data captured by the sensor coupled to the device. The device can process only that generated feature vector using a machine learning model to determine an action to perform given the detection. If the second device 114 determines that other feature vectors that likely represent the person 104 are not available, the second device 114 can generate a feature vector 122 of the person 104 using the image 120 captured by the living room camera 108 coupled to the second device 114.

The device can perform an analysis task for the object of interest at least using the one or more other feature vectors that likely represent the object of interest and were received from the one or more other devices. For example, the second device 114 can provide the first feature vector 118, generated by the first device 112, as input to a machine learning model 126 deployed in the analysis task engine 124.

The machine learning model 126 can be a neural network model trained to process an input that includes one or more feature vectors and to generate an output for the analysis task. Examples of the machine learning model can include a convolutional neural network (CNN) model, a recurrent neural network (RNN) model, a transformer model, or a combination of these. For example, the second device 114 can perform a facial recognition task using the first feature vector 118 that includes facial features of the person 104, to determine whether the person 104 is a resident who lives at the property 102.

The machine learning model 126 can use the first feature vector 118 as input to any appropriate layer within the machine learning model 126, e.g., which need not be the first layer in the machine learning model 126. For instance, the machine learning model 126 can include the last layers of a neural network model that is trained to perform an analysis task using input sensor data. The last layers can include one or more convolutional layers, one or more fully connected layers, or a combination of both. For example, the machine learning model 126 can include the last five layers (e.g., five fully connected layers) of a neural network model that includes 25 total layers. The first device 112 can generate the first feature vector 118 by processing the first image 116 using the layers of a neural network model that are before the last layers. After receiving the first feature vector 118, the second device 114 can use the last layers of the neural network model to process the first feature vector 118 to generate the result 128.

In some implementations, the device can generate its own feature vector for the potential object of interest, e.g., using image data captured by a camera coupled to the device. The device can use its own feature vector with the other feature vectors from the other devices during inference to perform an analysis task, e.g., a visual recognition task.

For example, the second device 114 can generate a second feature vector 122 for the person 104 using second image 120 captured by the second camera 154 (e.g., the living room camera 108) coupled to the second device 114. The second device 114 can use the first feature vector 118 obtained from the first device 112 and the second feature vector 122 to perform an analysis task. The second device 114 can provide both the first feature vector 118 and the second feature vector 122 as input to a machine learning model 126 deployed in the analysis task engine 124. For example, the second device 114 can perform a facial recognition task to determine whether the person is a resident who lives at the property 102 using both the first feature vector 118 and the second feature vector 122.

In some implementations, multiple devices can capture images of the same object of interest over a time period. The device that captures the most recent image of the object of interest can perform the analysis task. For example, the first device 112 can obtain the first feature vector 118 generated from the first image 116 captured by the first camera 152 at the time t1. The second device 114 can obtain the second feature vector 122 generated from the second image 120 captured by the second camera 154 at the time t2 that is later than t1. The second device 114 can perform the analysis task using the second feature vector 122 generated by the second device 114 and the first feature vector 118 obtained from the first device 112.

In some implementations, different devices can perform different tasks. For example, the first device 112 associated with the doorbell camera 106 can perform a person detection task, and the second device 114 associated with the living room camera 108 can perform a person tracking task. The feature vectors generated from sensor data by different devices may not be task specific. A feature vector generated using a first visual recognition task can represent features of an object and can be shared to another device that performs a second different visual recognition task. For example, the first feature vector 118 generated for a person detection task can depict features of a person detected in the first image 116. The first feature vector 118 is not specific to the person detection task and can be shared with the second device 114 that performs a person tracking task.

The device can obtain a result 128 of the analysis task and can perform an action using the result 128 of the analysis task. For example, the second device 114 can obtain a facial recognition result for the person 104 and can send the facial recognition result to the property monitoring system 150. If the facial recognition result indicates that the person 104 is not a resident who lives at the property 102 or otherwise satisfies one or more other criteria, the property monitoring system 150 can send a notification to a device of a user of the property monitoring system 150.

In some implementations, the system can perform cross-sensor tracking of an object using the techniques described in this specification. Feature vectors of a detected object generated from sensor data obtained from one sensor can be combined with feature vectors of the same object, e.g., or what the second device 114 predicts is likely the same object, generated from sensor data obtained from another sensor on the property. By analyzing the two feature vectors, the property monitoring system 150 can determine whether the objects detected at different times and using different sensors are likely the same object. Thus, the system can perform cross-sensor (e.g., cross-camera) and cross-time tracking of the object.

In some implementations, the property monitoring system 150 can provide a more comprehensive representation of an object of interest using the techniques described in this specification. Feature vectors extracted from a sensor with a limited view of an object of interest can be enhanced by combining the feature vectors with the limited view with feature vectors obtained from another sensor. This enhancement can improve downstream processing compared to other systems, e.g., by addressing limitations such as insufficient detail, lack of contextual information, or both. For example, sensor data from the first sensor may encode insufficient details of an object of interest for a particular type of analysis because the object is far from the camera. Sensor data from the second sensor may lack contextual information because the sensor data from the second sensor may be a close-up view, e.g., a close-up view that misses the clothing of a person but captures the face of the person well. By combining one or more feature vectors generated from sensor data of the first sensor and one or more feature vectors generated from sensor data of the second sensor, e.g., a full-body view and a close-up view, the system can improve high-resolution information, contextual information, or both, providing a more comprehensive representation to accurately identify the object of interest, e.g., the person.

The property monitoring system 150 is an example of a system implemented as computer programs on one or more computers in one or more locations, in which the systems, components, and techniques described in this specification are implemented. The devices 112 and 114 can include personal computers, mobile communication devices, edge computers, and other devices that can send and receive data over a network 140. The network 140, such as a local area network (“LAN”), wide area network (“WAN”), the Internet, or a combination thereof, connects the devices 112 and 114, the cameras 152 and 154, and the property monitoring system 150. The property monitoring system 150 can use a single computer or multiple computers operating in conjunction with one another, including, for example, a set of remote computers deployed as a cloud computing service.

The property monitoring system 150 can include several different functional components, including the first device 112, the second device 114, and the analysis task engine 124. The first and second devices, the analysis task engine 124, or a combination of these, can include one or more data processing apparatuses, can be implemented in code, or a combination of both. For instance, each of the devices 112 and 114 and the analysis task engine 124 can include one or more data processors and instructions that cause the one or more data processors to perform the operations discussed herein.

The various functional components of the property monitoring system 150 can be installed on one or more computers as separate functional components or as different modules of the same functional component. For example, the components, including the analysis task engine 124 of the property monitoring system 150 can be implemented as computer programs installed on one or more computers in one or more locations that are coupled to each through a network. In cloud-based systems for example, these components can be implemented by individual computing nodes of a distributed computing system.

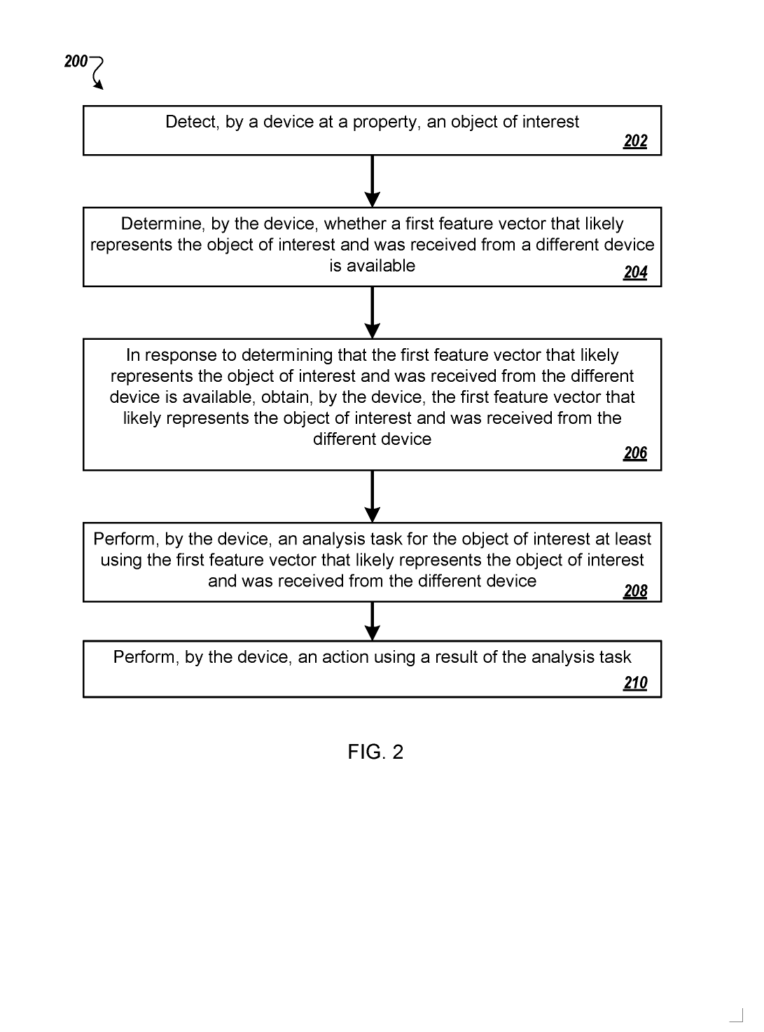

FIG. 2 is a flow diagram of a process 200 for the property monitoring system 150. For example, the process 200 can be used by the second device 114, or another system that implements the analysis task engine 124, from the environment 100.

A system detects an object of interest (202). In some implementations, the system can receive data indicating that an object of interest has been detected. For example, referring to FIG. 1, the second device 114 can receive a notification from the first device 112. The notification can indicate that a person 104 has been detected by the first device 112 and the second device 114 can be instructed to track the person 104 who is moving towards the field of view of a camera 108 coupled to the second device 114.

In some implementations, the system can detect an object interest using sensor data captured by a sensor coupled to the system. For example, the second device 114 can include the second camera 154. The second device 114 can detect an object of interest using the second image 120 captured by the second camera 154. In some cases, the second device can detect the object of interest by processing the sensor data using a machine learning model trained to detect objects of interest.

The system determines whether a first feature vector that likely represents the object of interest and was received from a different device is available (204). In some implementations, the feature vector can be generated by the different device by processing first sensor data captured by the first sensor coupled to the different device using a machine learning mode, such as a feature extraction neural network model. In some implementations, the feature vector can be stored on the different device.

In some implementations, the system can receive the first feature vector in response to a detection of an event by the different device. For example, after the first device 112 detects a weapon, the first device can send the feature vector of the weapon to the second device 114. Upon receipt of the feature vector, the second device 114 can perform further analysis of the weapon using at least the feature vector of the weapon received from the first device 112. The feature vector of the weapon can be a feature vector used to detect the weapon.

In some implementations, in response to the system detecting an event, the system can request the first feature vector, and in response to requesting the first feature vector, the system can receive the first feature. For example, the second device can receive an alarm indicating that a residence has been broken into. The second device can retrieve a feature vector of a person recently detected by the first device that is coupled to a front door camera 106.

In response to determining that the first feature vector that likely represents the object of interest and was received from the different device is available, the system obtains the first feature vector that likely represents the object of interest and was received from the different device (206). By sharing the feature vector of the object interest instead of sharing the sensor data of the object of interest, the system can reduce the amount of computation, memory, or both, required by the second device 114 because the second device 114 does not need to regenerate the first feature vector that was available from the first device 112. In some implementations, the first device 112 already generated the first feature vector for an analysis task performed by the first device, and thus the first feature vector can be reused by the second device. By sharing the feature vector of the object interest instead of sharing the sensor data of the object of interest, the system can improve data privacy because raw sensor data is kept within the first device 112 and is not shared with the second device 114.

The system performs an analysis task for the object of interest at least using the first feature vector that likely represents the object of interest and was received from the different device (208). For example, after the first device 112 detects a pet, the second device 114 that implements a pet analysis engine can process the feature vector of the pet received from the first device using a pet recognition model to determine whether the pet likely belongs to a resident of the property 102.

In some implementations, the system can generate a second feature vector for the object of interest using sensor data captured by a sensor coupled to the system. In some implementations, the first feature vector and the second feature vector can represent the object of interest from different perspectives, different types of sensor data, different settings for the same type of sensor data, or a combination of these. Different perspectives can include different viewing angles, different viewing distances, or both. Different settings for the same type of sensor data can include sensor data captured with infrared settings, e.g., for a dimly lit area such as outdoors, and separate sensor data captured with visible light settings, e.g., for a better lit area such as indoors.

In some implementations, the first feature vector and the second feature vector can represent the object of interest from different angles. For example, the first feature vector 118 can be generated from the first image 116 characterizing a frontal view of the person 104, and the second feature vector 122 can be generated from the second image 120 characterizing a profile view of the person 104.

In some implementations, the first feature vector and the second feature vector can represent the object of interest from different distances. For example, the first feature vector 118 can be generated from the first image 116 characterizing a face of the person 104 generated by a first living room camera 108 that is closer to the person 104 than a second camera 110. The second feature vector 122 can be generated from the second image 120 characterizing the whole body of the person 104 generated by a second living room camera 110 that is further away from the person 104 than the first camera 108. By using both the face feature and whole-body feature of the person, the system can more accurately determine the identity of the person, e.g., whether the person is a resident of the property.

In some implementations, the system can perform the analysis task for the object of interest using: (i) the second feature vector for the object of interest generated using the sensor data captured by the sensor coupled to the device; and (ii) the first feature vector that likely represents the object of interest and was received from the different device. Using the features vectors that represent the object of interest from more perspectives, different perspectives, or both, the system can more accurately perform an analysis task, such as a visual recognition task.

In some implementations, the system can perform the analysis task for the object of interest using two or more feature vectors generated using sensor data captured by the sensor coupled to the device and two or more feature vectors that were received from one or more different devices. For example, the system can perform the analysis task using two, three, four, or five feature vectors that are obtained from two, three, four, or five different devices.

In some implementations, the system can perform the analysis task for the object of interest using a combined feature vector generated using the first feature vector and the second feature vector. The combined feature vector can be an addition, a subtraction, a concatenation, a product, a division, or any other appropriate combination, of the multiple feature vectors, e.g., the first feature vector and the second feature vector. For example, the first feature vector can be a vector of length 512, and the second feature vector can be a vector of length 256. The combined feature vector can be a concatenation of the two feature vectors, e.g., a vector of length 768.

In some implementations, the system can sequentially provide the first feature vector and the second feature vector as input to an artificial intelligence model. The artificial intelligence model can store, in memory, an intermediate value generated from a first input. The artificial intelligence model can use the intermediate value to process a second input. The artificial intelligence model can generate an output for the analysis task. The system can obtain the output for the analysis task after the artificial intelligence model processes all of the input.

The machine learning model can be any appropriate type of model. In some implementations, the system can sequentially provide a first feature vector and a second feature vector as an input to the machine learning model. In some implementations, the system can generate a combination (e.g., a concatenation) of the first feature vector and the second feature vector and can provide the combination as the input to the machine learning model.

For example, the machine learning model can be a RNN and the system can sequentially provide a first feature vector and a second feature vector as input to the RNN. The RNN can store, in memory, an intermediate value generated from a first input, e.g., the first feature vector. The RNN can use the intermediate value to process the second input, e.g., the second feature vector. The RNN can generate an output for the analysis task. The system can obtain the output for the analysis task after the RNN processes all of the input.

In some implementations, the system can perform the analysis task for the object of interest using: (i) the first feature vector that likely represents the object of interest and was received from the different device, and (ii) sensor data captured by a sensor coupled to the system. The system can provide the first feature vector and the sensor data captured by the sensor coupled to the system as input to an artificial intelligence model. The system can obtain the output for the analysis task after the artificial intelligence model processes all of the input.

In some implementations, the system can perform the analysis task for the object of interest using: (i) the first feature vector that likely represents the object of interest and was received from the first different device, and (ii) the second feature vector that likely represents the object of interest and was received from the second different device. The system associated with the third device can process the pre-processed sensor data, e.g., the first feature vector and the second feature vector, from the multiple devices. The system can provide the first feature vector and the second feature vector as input to an artificial intelligence model. The system can obtain the output for the analysis task after the artificial intelligence model processes the first feature vector and the second feature vector. Therefore, the computation load of processing sensor data obtained at the first device and the second device is distributed at the first device, the second device, and the third device. Thus, the computation load at each device can be reduced compared to performing the analysis task at the one or two devices that captures the sensor data.

The system performs an action using a result of the analysis task (210). In some implementations, the system can determine that the result of the analysis task is likely related to a monitoring system action. In response to determining that the result of the analysis task is likely related to the monitoring system action, the system can send the result of the analysis task to a monitoring system. For example, the system can trigger a monitoring system action using the result of the analysis task, e.g., setting off an alarm.

In some implementations, the system can determine that the result of the analysis task is not likely related to a monitoring system action. In response to determining that the result of the analysis task is not likely related to the monitoring system action, the system can delete the first feature vector from a memory of the device.

In some implementations, the system can determine, using the result of the analysis task, that an event criterion is not satisfied, the system can delete the first feature vector from a memory of the device. For example, the system can determine that the result of the analysis task indicates that there is not a stranger at the property, and the system can delete the first feature vector of a detected person from the memory of the device.

In some implementations, the system can determine, using the result of the analysis task, that the object of interest is not actually an object of interest, the system can delete the first feature vector from a memory of the device. For example, the system can determine that the result of the analysis task indicates that the object of interest represented in the first feature vector and the second feature vector is not a weapon, and the system can delete the first feature vector and the second feature vector from a memory of the device.

In some implementations, the system can process the first feature vector and the second feature vector using a machine learning model trained to determine whether the first feature vector and the second feature vector likely represent the same object. For example, the machine learning model can be trained with training examples that include pairs of feature vectors characterizing the same objects and different objects. In some implementations, the system can obtain the result of the analysis task indicating whether the first feature vector and the second feature vector likely represent the same object. For example, the result can indicate whether the first feature vector and the second feature vector likely represent the same person.

If the system determines that the first feature vector and the second feature vector likely represent the same object, the system can perform the analysis task for the object of interest using a combined feature vector generated using the first feature vector and the second feature vector. If the system determines that the first feature vector and the second feature vector likely do not represent the same object, the system can delete the first feature vector from a memory of the device.

The order of operations in the process 200 described above is illustrative only, and the operations in the process 200 can be performed in different orders. In some implementations, the process 200 can include additional operations, fewer operations, or some of the operations can be divided into multiple operations.

For situations in which the systems discussed here collect personal information about people, or may make use of personal information, the people may be provided with an opportunity to control whether programs or features collect personal information (e.g., information about a person’s activities, a person’s preferences, or a person’s current location), or to control whether and/or how the system operates. In addition, certain data may be anonymized in one or more ways before it is stored or used, so that personally identifiable information is removed. For example, a person’s identity may be anonymized so that no personally identifiable information can be determined for the person, or a person’s geographic location may be generalized where location information is obtained (such as to a city, ZIP code, or state level), so that a particular location of a person cannot be determined. Thus, the person may have control over how information is collected about him or her and used.

In this specification the term “engine” is used broadly to refer to a software-based system, subsystem, or process that is programmed to perform one or more specific functions. Generally, an engine will be implemented as one or more software modules or components, installed on one or more computers in one or more locations. In some instances, one or more computers will be dedicated to a particular engine. In some instances, multiple engines can be installed and running on the same computer or computers.

In this specification, the term “likely” is used to mean that there is a likelihood that something might occur and that likelihood satisfies a likelihood threshold. For instance, when determining that an object is likely depicted in an image, a system would determine a likelihood that the object is depicted in the image. The system would then determine whether the likelihood satisfies, e.g., is greater than or equal to, a likelihood threshold by comparing the two values. If so, the system determines that the object is likely depicted in the image. If not, the system determines that the object is not likely depicted in the image.

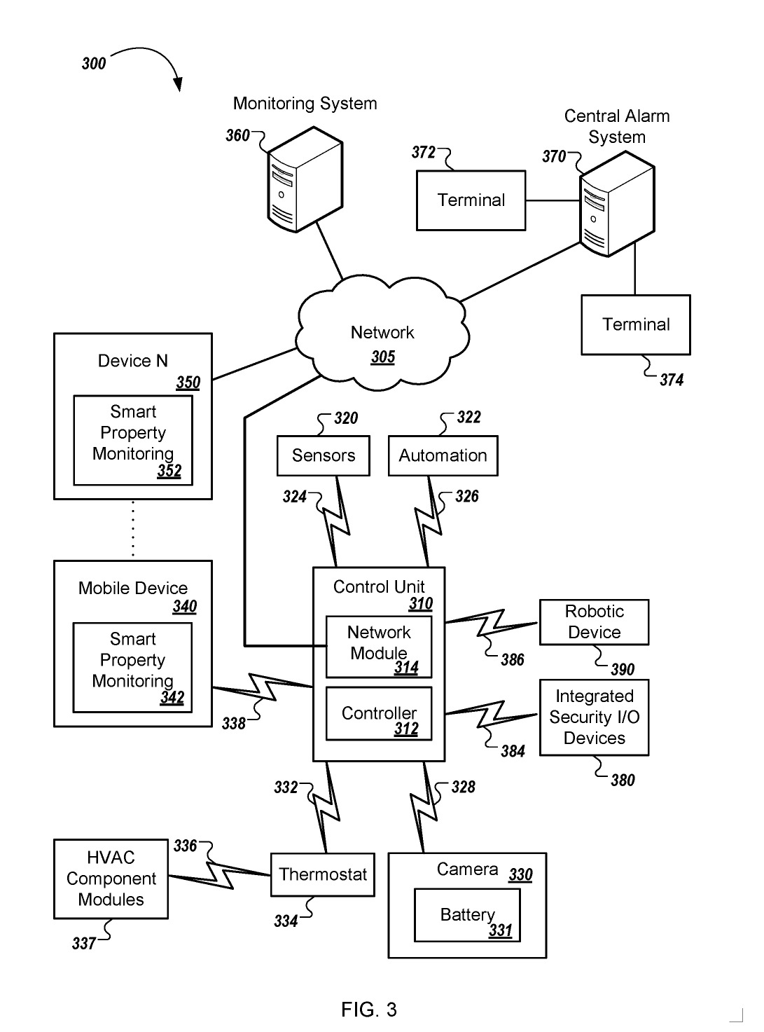

FIG. 3 is a diagram illustrating an example of an environment 300, e.g., for monitoring a property. The property can be any appropriate type of property, such as a home, a business, or a combination of both. The environment 300 includes a network 305, a control unit 310, one or more devices 340 and 350, a monitoring system 360, a central alarm system 370, or a combination of two or more of these. In some examples, the network 305 facilitates communications between two or more of the control unit 310, the one or more devices 340 and 350, the monitoring system 360, and the central alarm system 370.

The network 305 is configured to enable exchange of electronic communications between devices connected to the network 305. For example, the network 305 can be configured to enable exchange of electronic communications between the control unit 310, the one or more devices 340 and 350, the monitoring system 360, and the central alarm system 370. The network 305 can include, for example, one or more of the Internet, Wide Area Networks (“WANs”), Local Area Networks (“LANs”), analog or digital wired and wireless telephone networks (e.g., a public switched telephone network (“PSTN”), Integrated Services Digital Network (“ISDN”), a cellular network, and Digital Subscriber Line (“DSL”)), radio, television, cable, satellite, any other delivery or tunneling mechanism for carrying data, or a combination of these. The network 305 can include multiple networks or subnetworks, each of which can include, for example, a wired or wireless data pathway. The network 305 can include a circuit-switched network, a packet-switched data network, or any other network able to carry electronic communications (e.g., data or voice communications). For example, the network 305 can include networks based on the Internet protocol (“IP”), asynchronous transfer mode (“ATM”), the PSTN, packet-switched networks based on IP, X.25, or Frame Relay, or other comparable technologies and can support voice using, for example, voice over IP (“VoIP”), or other comparable protocols used for voice communications. The network 305 can include one or more networks that include wireless data channels and wireless voice channels. The network 305 can be a broadband network.

The control unit 310 includes a controller 312 and a network module 314. The controller 312 is configured to control a control unit monitoring system, e.g., a control unit system, that includes the control unit 310. In some examples, the controller 312 can include one or more processors or other control circuitry configured to execute instructions of a program that controls operation of a control unit system. In these examples, the controller 312 can be configured to receive input from sensors, or other devices included in the control unit system and control operations of devices at the property, e.g., speakers, displays, lights, doors, other appropriate devices, or a combination of these. For example, the controller 312 can be configured to control operation of the network module 314 included in the control unit 310.

The network module 314 is a communication device configured to exchange communications over the network 305. The network module 314 can be a wireless communication module configured to exchange wireless, wired, or a combination of both, communications over the network 305. For example, the network module 314 can be a wireless communication device configured to exchange communications over a wireless data channel and a wireless voice channel. In some examples, the network module 314 can transmit alarm data over a wireless data channel and establish a two-way voice communication session over a wireless voice channel. The wireless communication device can include one or more of a LTE module, a GSM module, a radio modem, a cellular transmission module, or any type of module configured to exchange communications in any appropriate type of wireless or wired format.

The network module 314 can be a wired communication module configured to exchange communications over the network 305 using a wired connection. For instance, the network module 314 can be a modem, a network interface card, or another type of network interface device. The network module 314 can be an Ethernet network card configured to enable the control unit 310 to communicate over a local area network, the Internet, or a combination of both. The network module 314 can be a voice band modem configured to enable the alarm panel to communicate over the telephone lines of Plain Old Telephone Systems (“POTS”).

The control unit system that includes the control unit 310 can include one or more sensors 320. For example, the environment 300 can include multiple sensors 320. The sensors 320 can include a lock sensor, a contact sensor, a motion sensor, a camera (e.g., a camera 330), a flow meter, any other type of sensor included in a control unit system, or a combination of two or more of these. The sensors 320 can include an environmental sensor, such as a temperature sensor, a water sensor, a rain sensor, a wind sensor, a light sensor, a smoke detector, a carbon monoxide detector, or an air quality sensor, to name a few additional examples. The sensors 320 can include a health monitoring sensor, such as a prescription bottle sensor that monitors taking of prescriptions, a blood pressure sensor, a blood sugar sensor, or a bed mat configured to sense presence of liquid (e.g., bodily fluids) on the bed mat. In some examples, the health monitoring sensor can be a wearable sensor that attaches to a person, e.g., a user, at the property. The health monitoring sensor can collect various health data, including pulse, heartrate, respiration rate, sugar or glucose level, bodily temperature, motion data, or a combination of these. The sensors 320 can include a radio-frequency identification (“RFID”) sensor that identifies a particular article that includes a pre-assigned RFID tag.

The control unit 310 can communicate with a module 322 and a camera 330 to perform monitoring. The module 322 is connected to one or more devices that enable property automation, e.g., home or business automation. For instance, the module 322 can connect to, and be configured to control operation of, one or more lighting systems. The module 322 can connect to, and be configured to control operation of, one or more electronic locks, e.g., control Z-Wave locks using wireless communications in the Z-Wave protocol. In some examples, the module 322 can connect to, and be configured to control operation of, one or more appliances. The module 322 can include multiple sub-modules that are each specific to a type of device being controlled in an automated manner. The module 322 can control the one or more devices using commands received from the control unit 310. For instance, the module 322 can receive a command from the control unit 310, which command was sent using data captured by the camera 330 that depicts an area. In response, the module 322 can cause a lighting system to illuminate an area to provide better lighting in the area, and a higher likelihood that the camera 330 can capture a subsequent image of the area that depicts more accurate data of the area.

The camera 330 can be an image camera or other type of optical sensing device configured to capture one or more images. For instance, the camera 330 can be configured to capture images of an area within a property monitored by the control unit 310. The camera 330 can be configured to capture single, static images of the area; video of the area, e.g., a sequence of images; or a combination of both. The sequence of images can be a sequence of frames, e.g., when the video is compressed using a video codec. The image captured by the camera can be any appropriate type of image, e.g., a frame. The camera 330 can be controlled using commands received from the control unit 310 or another device in the property monitoring system, e.g., a device 350.

The camera 330 can be triggered using any appropriate techniques, can capture images continuously, or a combination of both. For instance, a Passive Infra-Red (“PIR”) motion sensor can be built into the camera 330 and used to trigger the camera 330 to capture one or more images when motion is detected. The camera 330 can include a microwave motion sensor built into the camera which is used to trigger the camera 330 to capture one or more images when motion is detected. The camera 330 can have a “normally open” or “normally closed” digital input that can trigger capture of one or more images when external sensors detect motion or other events. The external sensors can include another sensor from the sensors 320, PIR, or door or window sensors, to name a few examples. In some implementations, the camera 330 receives a command to capture an image, e.g., when external devices detect motion or another potential alarm event or in response to a request from a device. The camera 330 can receive the command from the controller 312, directly from one of the sensors 320, or a combination of both.

In some examples, the camera 330 triggers integrated or external illuminators to improve image quality when the scene is dark. Some examples of illuminators can include Infra-Red, Z-wave controlled “white” lights, lights controlled by the module 322, or a combination of these. An integrated or separate light sensor can be used to determine if illumination is desired and can result in increased image quality.

The camera 330 can be programmed with any combination of time schedule, day schedule, system “arming state”, other variables, or a combination of these, to determine whether images should be captured when one or more triggers occur. The camera 330 can enter a low-power mode when not capturing images. In this case, the camera 330 can wake periodically to check for inbound messages from the controller 312 or another device. The camera 330 can be powered by internal, replaceable batteries, e.g., if located remotely from the control unit 310. The camera 330 can employ a small solar cell to recharge the battery when light is available. The camera 330 can be powered by a wired power supply, e.g., the controller’s 312 power supply if the camera 330 is co-located with the controller 312.

In some implementations, the camera 330 communicates directly with the monitoring system 360 over the network 305. In these implementations, image data captured by the camera 330 need not pass through the control unit 310. The camera 330 can receive commands related to operation from the monitoring system 360, provide images to the monitoring system 360, or a combination of both.

The environment 300 can include one or more thermostats 334, e.g., to perform dynamic environmental control at the property. The thermostat 334 is configured to monitor temperature of the property, energy consumption of a heating, ventilation, and air conditioning (“HVAC”) system associated with the thermostat 334, or both. In some examples, the thermostat 334 is configured to provide control of environmental (e.g., temperature) settings. In some implementations, the thermostat 334 can additionally or alternatively receive data relating to activity at a property; environmental data at a property, e.g., at various locations indoors or outdoors or both at the property; or a combination of both. The thermostat 334 can measure or estimate energy consumption of the HVAC system associated with the thermostat. The thermostat 334 can estimate energy consumption, for example, using data that indicates usage of one or more components of the HVAC system associated with the thermostat 334. The thermostat 334 can communicate various data, e.g., temperature, energy, or both, with the control unit 310. In some examples, the thermostat 334 can control the environment, e.g., temperature, settings in response to commands received from the control unit 310.

In some implementations, the thermostat 334 is a dynamically programmable thermostat and can be integrated with the control unit 310. For example, the dynamically programmable thermostat 334 can include the control unit 310, e.g., as an internal component to the dynamically programmable thermostat 334. In some examples, the control unit 310 can be a gateway device that communicates with the dynamically programmable thermostat 334. In some implementations, the thermostat 334 is controlled via one or more modules 322.

The environment 300 can include the HVAC system or otherwise be connected to the HVAC system. For instance, the environment 300 can include one or more HVAC modules 337. The HVAC modules 337 can be connected to one or more components of the HVAC system associated with a property. A module 337 can be configured to capture sensor data from, control operation of, or both, corresponding components of the HVAC system. In some implementations, the module 337 is configured to monitor energy consumption of an HVAC system component, for example, by directly measuring the energy consumption of the HVAC system components or by estimating the energy usage of the one or more HVAC system components by detecting usage of components of the HVAC system. The module 337 can communicate energy monitoring information, the state of the HVAC system components, or both, to the thermostat 334. The module 337 can control the one or more components of the HVAC system in response to receipt of commands received from the thermostat 334.

In some examples, the environment 300 includes one or more robotic devices 390. The robotic devices 390 can be any type of robots that are capable of moving, such as an aerial drone, a land-based robot, or a combination of both. The robotic devices 390 can take actions, such as capture sensor data or other actions that assist in security monitoring, property automation, or a combination of both. For example, the robotic devices 390 can include robots capable of moving throughout a property using automated navigation control technology, user input control provided by a user, or a combination of both. The robotic devices 390 can fly, roll, walk, or otherwise move about the property. The robotic devices 390 can include helicopter type devices (e.g., quad copters), rolling helicopter type devices (e.g., roller copter devices that can fly and roll along the ground, walls, or ceiling) and land vehicle type devices (e.g., automated cars that drive around a property). In some examples, the robotic devices 390 can be robotic devices 390 that are intended for other purposes and merely associated with the environment 300 for use in appropriate circumstances. For instance, a robotic vacuum cleaner device can be associated with the environment 300 as one of the robotic devices 390 and can be controlled to take action responsive to monitoring system events.

In some examples, the robotic devices 390 automatically navigate within a property. In these examples, the robotic devices 390 include sensors and control processors that guide movement of the robotic devices 390 within the property. For instance, the robotic devices 390 can navigate within the property using one or more cameras, one or more proximity sensors, one or more gyroscopes, one or more accelerometers, one or more magnetometers, a global positioning system (“GPS”) unit, an altimeter, one or more sonar or laser sensors, any other types of sensors that aid in navigation about a space, or a combination of these. The robotic devices 390 can include control processors that process output from the various sensors and control the robotic devices 390 to move along a path that reaches the desired destination, avoids obstacles, or a combination of both. In this regard, the control processors detect walls or other obstacles in the property and guide movement of the robotic devices 390 in a manner that avoids the walls and other obstacles.

In some implementations, the robotic devices 390 can store data that describes attributes of the property. For instance, the robotic devices 390 can store a floorplan, a three-dimensional model of the property, or a combination of both, that enable the robotic devices 390 to navigate the property. During initial configuration, the robotic devices 390 can receive the data describing attributes of the property, determine a frame of reference to the data (e.g., a property or reference location in the property), and navigate the property using the frame of reference and the data describing attributes of the property. In some examples, initial configuration of the robotic devices 390 can include learning one or more navigation patterns in which a user provides input to control the robotic devices 390 to perform a specific navigation action (e.g., fly to an upstairs bedroom and spin around while capturing video and then return to a property charging base). In this regard, the robotic devices 390 can learn and store the navigation patterns such that the robotic devices 390 can automatically repeat the specific navigation actions upon a later request.

In some examples, the robotic devices 390 can include data capture devices. In these examples, the robotic devices 390 can include, as data capture devices, one or more cameras, one or more motion sensors, one or more microphones, one or more biometric data collection tools, one or more temperature sensors, one or more humidity sensors, one or more air flow sensors, any other type of sensor that can be useful in capturing monitoring data related to the property and users in the property, or a combination of these. The one or more biometric data collection tools can be configured to collect biometric samples of a person in the property with or without contact of the person. For instance, the biometric data collection tools can include a fingerprint scanner, a hair sample collection tool, a skin cell collection tool, or any other tool that allows the robotic devices 390 to take and store a biometric sample that can be used to identify the person (e.g., a biometric sample with DNA that can be used for DNA testing).

In some implementations, the robotic devices 390 can include output devices. In these implementations, the robotic devices 390 can include one or more displays, one or more speakers, any other type of output devices that allow the robotic devices 390 to communicate information, e.g., to a nearby user or another type of person, or a combination of these.

The robotic devices 390 can include a communication module that enables the robotic devices 390 to communicate with the control unit 310, each other, other devices, or a combination of these. The communication module can be a wireless communication module that allows the robotic devices 390 to communicate wirelessly. For instance, the communication module can be a Wi-Fi module that enables the robotic devices 390 to communicate over a local wireless network at the property. Other types of short-range wireless communication protocols, such as 900 MHz wireless communication, Bluetooth, Bluetooth LE, Z-wave, Zigbee, Matter, or any other appropriate type of wireless communication, can be used to allow the robotic devices 390 to communicate with other devices, e.g., in or off the property. In some implementations, the robotic devices 390 can communicate with each other or with other devices of the environment 300 through the network 305.

The robotic devices 390 can include processor and storage capabilities. The robotic devices 390 can include any one or more suitable processing devices that enable the robotic devices 390 to execute instructions, operate applications, perform the actions described throughout this specification, or a combination of these. In some examples, the robotic devices 390 can include solid-state electronic storage that enables the robotic devices 390 to store applications, configuration data, collected sensor data, any other type of information available to the robotic devices 390, or a combination of two or more of these.

The robotic devices 390 can process captured data locally, provide captured data to one or more other devices for processing, e.g., the control unit 310 or the monitoring system 360, or a combination of both. For instance, the robotic device 390 can provide the images to the control unit 310 for processing. In some examples, the robotic device 390 can process the images to determine an identification of the items.

One or more of the robotic devices 390 can be associated with one or more charging stations. The charging stations can be located at a predefined home base or reference location in the property. The robotic devices 390 can be configured to navigate to one of the charging stations after completion of one or more tasks needed to be performed, e.g., for the environment 300. For instance, after completion of a monitoring operation or upon instruction by the control unit 310, a robotic device 390 can be configured to automatically fly to and connect with, e.g., land on, one of the charging stations. In this regard, a robotic device 390 can automatically recharge one or more batteries included in the robotic device 390 so that the robotic device 390 is less likely to need recharging when the environment 300 requires use of the robotic device 390, e.g., absent other concerns for the robotic device 390.

The charging stations can be contact-based charging stations, wireless charging stations, or a combination of both. For contact-based charging stations, the robotic devices 390 can have readily accessible points of contact to which a robotic device 390 can contact on the charging station. For instance, a helicopter type robotic device can have an electronic contact on a portion of its landing gear that rests on and couples with an electronic pad of a charging station when the helicopter type robotic device lands on the charging station. The electronic contact on the robotic device 390 can include a cover that opens to expose the electronic contact when the robotic device is charging and closes to cover and insulate the electronic contact when the robotic device 390 is in operation.

For wireless charging stations, the robotic devices 390 can charge through a wireless exchange of power. In these instances, a robotic device 390 needs only position itself closely enough to a wireless charging station for the wireless exchange of power to occur. In this regard, the positioning needed to land at a predefined home base or reference location in the property can be less precise than with a contact-based charging station. Based on the robotic devices 390 landing at a wireless charging station, the wireless charging station can output a wireless signal that the robotic device 390 receives and converts to a power signal that charges a battery maintained on the robotic device 390. As described in this specification, a robotic device 390 landing or coupling with a charging station can include a robotic device 390 positioning itself within a threshold distance of a wireless charging station such that the robotic device 390 is able to charge its battery.

In some implementations, one or more of the robotic devices 390 has an assigned charging station. In these implementations, the number of robotic devices 390 can equal the number of charging stations. In these implementations, the robotic devices 390 can always navigate to the specific charging station assigned to that robotic device 390. For instance, a first robotic device can always use a first charging station and a second robotic device can always use a second charging station.

In some examples, the robotic devices 390 can share charging stations. For instance, the robotic devices 390 can use one or more community charging stations that are capable of charging multiple robotic devices 390, e.g., substantially concurrently or separately or a combination of both at different times. The community charging station can be configured to charge multiple robotic devices 390 at substantially the same time, e.g., the community charging station can begin charging a first robotic device and then, while charging the first robotic device, begin charging a second robotic device five minutes later. The community charging station can be configured to charge multiple robotic devices 390 in serial such that the multiple robotic devices 390 take turns charging and, when fully charged, return to a predefined home base or reference location or another location in the property that is not associated with a charging station. The number of community charging stations can be less than the number of robotic devices 390.

In some instances, the charging stations might not be assigned to specific robotic devices 390 and can be capable of charging any of the robotic devices 390. In this regard, the robotic devices 390 can use any suitable, unoccupied charging station when not in use, e.g., when not performing an operation for the environment 300. For instance, when one of the robotic devices 390 has completed an operation or is in need of battery charge, the control unit 310 can reference a stored table of the occupancy status of each charging station and instructs the robotic device to navigate to the nearest charging station that has at least one unoccupied charger.

The environment 300 can include one or more integrated security devices 380. The one or more integrated security devices can include any type of device used to provide alerts based on received sensor data. For instance, the one or more control units 310 can provide one or more alerts to the one or more integrated security input/output devices 380. In some examples, the one or more control units 310 can receive sensor data from the sensors 320 and determine whether to provide an alert, or a message to cause presentation of an alert, to the one or more integrated security input/output devices 380.

The sensors 320, the module 322, the camera 330, the thermostat 334, the module 337, the integrated security devices 380, and the robotic devices 390, can communicate with the controller 312 over communication links 324, 326, 328, 332, 336, 338, 384, and 386. The communication links 324, 326, 328, 332, 336, 338, 384, and 386 can be a wired or wireless data pathway configured to transmit signals between any combination of the sensors 320, the module 322, the camera 330, the thermostat 334, the module 337, the integrated security devices 380, the robotic devices 390, or the controller 312. The sensors 320, the module 322, the camera 330, the thermostat 334, the module 337, the integrated security devices 380, and the robotic devices 390, can continuously transmit sensed values to the controller 312, periodically transmit sensed values to the controller 312, or transmit sensed values to the controller 312 in response to a change in a sensed value, a request, or both. In some implementations, the robotic devices 390 can communicate with the monitoring system 360 over network 305. The robotic devices 390 can connect and communicate with the monitoring system 360 using a Wi-Fi or a cellular connection or any other appropriate type of connection.

The communication links 324, 326, 328, 332, 336, 338, 384, and 386 can include any appropriate type of network, such as a local network. The sensors 320, the module 322, the camera 330, the thermostat 334, the robotic devices 390 and the integrated security devices 380, and the controller 312 can exchange data and commands over the network.

The monitoring system 360 can include one or more electronic devices, e.g., one or more computers. The monitoring system 360 is configured to provide monitoring services by exchanging electronic communications with the control unit 310, the one or more devices 340 and 350, the central alarm system 370, or a combination of these, over the network 305. For example, the monitoring system 360 can be configured to monitor events (e.g., alarm events) generated by the control unit 310. In these examples, the monitoring system 360 can exchange electronic communications with the network module 314 included in the control unit 310 to receive information regarding events (e.g., alerts) detected by the control unit 310. The monitoring system 360 can receive information regarding events (e.g., alerts) from the one or more devices 340 and 350.

In some implementations, the monitoring system 360 might be configured to provide one or more services other than monitoring services. In these implementations, the monitoring system 360 might perform one or more operations described in this specification without providing any monitoring services, e.g., the monitoring system 360 might not be a monitoring system as described in the example shown in FIG. 3.

In some examples, the monitoring system 360 can route alert data received from the network module 314 or the one or more devices 340 and 350 to the central alarm system 370. For example, the monitoring system 360 can transmit the alert data to the central alarm system 370 over the network 305.

The monitoring system 360 can store sensor and image data received from the environment 300 and perform analysis of sensor and image data received from the environment 300. Based on the analysis, the monitoring system 360 can communicate with and control aspects of the control unit 310 or the one or more devices 340 and 350.

The monitoring system 360 can provide various monitoring services to the environment 300. For example, the monitoring system 360 can analyze the sensor, image, and other data to determine an activity pattern of a person of the property monitored by the environment 300. In some implementations, the monitoring system 360 can analyze the data for alarm conditions or can determine and perform actions at the property by issuing commands to one or more components of the environment 300, possibly through the control unit 310.

The central alarm system 370 is an electronic device, or multiple electronic devices, configured to provide alarm monitoring service by exchanging communications with the control unit 310, the one or more mobile devices 340 and 350, the monitoring system 360, or a combination of these, over the network 305. For example, the central alarm system 370 can be configured to monitor alerting events generated by the control unit 310. In these examples, the central alarm system 370 can exchange communications with the network module 314 included in the control unit 310 to receive information regarding alerting events detected by the control unit 310. The central alarm system 370 can receive information regarding alerting events from the one or more mobile devices 340 and 350, the monitoring system 360, or both. In some implementations, the central alarm system 370 can be implemented, at least in part if not entirely, on the monitoring system 360. In these implementations, the monitoring system 360 can perform the operations described with reference to the central alarm system 370.

The central alarm system 370 is connected to multiple terminals 372 and 374. The terminals 372 and 374 can be used by operators to process alerting events. For example, the central alarm system 370, e.g., as part of a first responder system, can route alerting data to the terminals 372 and 374 to enable an operator to process the alerting data. The terminals 372 and 374 can include general-purpose computers (e.g., desktop personal computers, workstations, or laptop computers) that are configured to receive alerting data from a computer in the central alarm system 370 and render a display of information using the alerting data.

For instance, the controller 312 can control the network module 314 to transmit, to the central alarm system 370, alerting data indicating that a sensor 320 detected motion from a motion sensor via the sensors 320. The central alarm system 370 can receive the alerting data and route the alerting data to the terminal 372 for processing by an operator associated with the terminal 372. The terminal 372 can render a display to the operator that includes information associated with the alerting event (e.g., the lock sensor data, the motion sensor data, the contact sensor data, etc.) and the operator can handle the alerting event based on the displayed information. In some implementations, the terminals 372 and 374 can be mobile devices or devices designed for a specific function. Although FIG. 3 illustrates two terminals for brevity, actual implementations can include more (and, perhaps, many more) terminals.

The one or more devices 340 and 350 are devices that can present content, e.g., host and display user interfaces, audio data, or both. For instance, the mobile device 340 is a mobile device that hosts or runs one or more native applications (e.g., the smart property application 342). The mobile device 340 can be a cellular phone or a non-cellular locally networked device with a display. The mobile device 340 can include a cell phone, a smart phone, a tablet PC, a personal digital assistant (“PDA”), or any other portable device configured to communicate over a network and present information. The mobile device 340 can perform functions unrelated to the monitoring system, such as placing personal telephone calls, playing music, playing video, displaying pictures, browsing the Internet, and maintaining an electronic calendar.

The mobile device 340 can include a smart property application 342. The smart property application 342 refers to a software/firmware program running on the corresponding mobile device that enables the user interface and features described throughout. The mobile device 340 can load or install the smart property application 342 using data received over a network or data received from local media. The smart property application 342 enables the mobile device 340 to receive and process image and sensor data from the monitoring system 360.

The device 350 can be a general-purpose computer (e.g., a desktop personal computer, a workstation, or a laptop computer) that is configured to communicate with the monitoring system 360, the control unit 310, or both, over the network 305. The device 350 can be configured to display a smart property user interface 352 that is generated by the device 350 or generated by the monitoring system 360. For example, the device 350 can be configured to display a user interface (e.g., a web page) generated using data provided by the monitoring system 360 that enables a user to perceive images captured by the camera 330, reports related to the monitoring system, or both. Although FIG. 3 illustrates two devices for brevity, actual implementations can include more (and, perhaps, many more) or fewer devices.

In some implementations, the one or more devices 340 and 350 communicate with and receive data from the control unit 310 using the communication link 338. For instance, the one or more devices 340 and 350 can communicate with the control unit 310 using various wireless protocols, or wired protocols such as Ethernet and USB, to connect the one or more devices 340 and 350 to the control unit 310, e.g., local security and automation equipment. The one or more devices 340 and 350 can use a local network, a wide area network, or a combination of both, to communicate with other components in the environment 300. The one or more devices 340 and 350 can connect locally to the sensors and other devices in the environment 300.

Although the one or more devices 340 and 350 are shown as communicating with the control unit 310, the one or more devices 340 and 350 can communicate directly with the sensors and other devices controlled by the control unit 310. In some implementations, the one or more devices 340 and 350 replace the control unit 310 and perform one or more of the functions of the control unit 310 for local monitoring and long range, offsite, or both, communication.

In some implementations, the one or more devices 340 and 350 receive monitoring system data captured by the control unit 310 through the network 305. The one or more devices 340 and 350 can receive the data from the control unit 310 through the network 305, the monitoring system 360 can relay data received from the control unit 310 to the one or more devices 340 and 350 through the network 305, or a combination of both. In this regard, the monitoring system 360 can facilitate communication between the one or more devices 340 and 350 and various other components in the environment 300.

In some implementations, the one or more devices 340 and 350 can be configured to switch whether the one or more devices 340 and 350 communicate with the control unit 310 directly (e.g., through communication link 338) or through the monitoring system 360 (e.g., through network 305) based on a location of the one or more devices 340 and 350. For instance, when the one or more devices 340 and 350 are located close to, e.g., within a threshold distance of, the control unit 310 and in range to communicate directly with the control unit 310, the one or more devices 340 and 350 use direct communication. When the one or more devices 340 and 350 are located far from, e.g., outside the threshold distance of, the control unit 310 and not in range to communicate directly with the control unit 310, the one or more devices 340 and 350 use communication through the monitoring system 360.

Although the one or more devices 340 and 350 are shown as being connected to the network 305, in some implementations, the one or more devices 340 and 350 are not connected to the network 305. In these implementations, the one or more devices 340 and 350 communicate directly with one or more of the monitoring system components and no network (e.g., Internet) connection or reliance on remote servers is needed.

In some implementations, the one or more devices 340 and 350 are used in conjunction with only local sensors and/or local devices in a house. In these implementations, the environment 300 includes the one or more devices 340 and 350, the sensors 320, the module 322, the camera 330, and the robotic devices 390. The one or more devices 340 and 350 receive data directly from the sensors 320, the module 322, the camera 330, the robotic devices 390, or a combination of these, and send data directly to the sensors 320, the module 322, the camera 330, the robotic devices 390, or a combination of these. The one or more devices 340 and 350 can provide the appropriate interface, processing, or both, to provide visual surveillance and reporting using data received from the various other components.

In some implementations, the environment 300 includes network 305 and the sensors 320, the module 322, the camera 330, the thermostat 334, and the robotic devices 390 are configured to communicate sensor and image data to the one or more devices 340 and 350 over network 305. In some implementations, the sensors 320, the module 322, the camera 330, the thermostat 334, and the robotic devices 390 are programmed, e.g., intelligent enough, to change the communication pathway from a direct local pathway when the one or more devices 340 and 350 are in close physical proximity to the sensors 320, the module 322, the camera 330, the thermostat 334, the robotic devices 390, or a combination of these, to a pathway over network 305 when the one or more devices 340 and 350 are farther from the sensors 320, the module 322, the camera 330, the thermostat 334, the robotic devices 390, or a combination of these.

In some examples, the monitoring system 360 leverages GPS information from the one or more devices 340 and 350 to determine whether the one or more devices 340 and 350 are close enough to the sensors 320, the module 322, the camera 330, the thermostat 334, the robotic devices 390, or a combination of these, to use the direct local pathway or whether the one or more devices 340 and 350 are far enough from the sensors 320, the module 322, the camera 330, the thermostat 334, the robotic devices 390, or a combination of these, that the pathway over network 305 is required. In some examples, the monitoring system 360 leverages status communications (e.g., pinging) between the one or more devices 340 and 350 and the sensors 320, the module 322, the camera 330, the thermostat 334, the robotic devices 390, or a combination of these, to determine whether communication using the direct local pathway is possible. If communication using the direct local pathway is possible, the one or more devices 340 and 350 communicate with the sensors 320, the module 322, the camera 330, the thermostat 334, the robotic devices 390, or a combination of these, using the direct local pathway. If communication using the direct local pathway is not possible, the one or more devices 340 and 350 communicate with the sensors 320, the module 322, the camera 330, the thermostat 334, the robotic devices 390, or a combination of these, using the pathway over network 305.

In some implementations, the environment 300 provides people with access to images captured by the camera 330 to aid in decision-making. The environment 300 can transmit the images captured by the camera 330 over a network, e.g., a wireless WAN, to the devices 340 and 350. Because transmission over a network can be relatively expensive, the environment 300 can use several techniques to reduce costs while providing access to significant levels of useful visual information (e.g., compressing data, down-sampling data, sending data only over inexpensive LAN connections, or other techniques).

In some implementations, a state of the environment 300, one or more components in the environment 300, and other events sensed by a component in the environment 300 can be used to enable/disable video/image recording devices (e.g., the camera 330). In these implementations, the camera 330 can be set to capture images on a periodic basis when the alarm system is armed in an “away” state, set not to capture images when the alarm system is armed in a “stay” state or disarmed, or a combination of both. In some examples, the camera 330 can be triggered to begin capturing images when the control unit 310 detects an event, such as an alarm event, a door-opening event for a door that leads to an area within a field of view of the camera 330, or motion in the area within the field of view of the camera 330. In some implementations, the camera 330 can capture images continuously, but the captured images can be stored or transmitted over a network when needed.

Although FIG. 3 depicts the monitoring system 360 as remote from the control unit 310, in some examples the control unit 310 can be a component of the monitoring system 360. For instance, both the monitoring system 360 and the control unit 310 can be physically located at a property that includes the sensors 320 or at a location outside the property.

In some examples, some of the sensors 320, the robotic devices 390, or a combination of both, might not be directly associated with the property. For instance, a sensor or a robotic device might be located at an adjacent property or on a vehicle that passes by the property. A system at the adjacent property or for the vehicle, e.g., that is in communication with the vehicle or the robotic device, can provide data from that sensor or robotic device to the control unit 310, the monitoring system 360, or a combination of both.

A number of implementations have been described. Nevertheless, it will be understood that various modifications can be made without departing from the spirit and scope of the disclosure. For example, various forms of the flows shown above can be used, with operations re-ordered, added, or removed.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, a data processing apparatus. Alternatively or in addition, the program instructions can be encoded on an artificially-generated propagated signal, e.g., a machine-generated electrical, optical, or electromagnetic signal, that is generated to encode information for transmission to a suitable receiver apparatus for execution by a data processing apparatus. One or more computer storage media can include a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can be or include special purpose logic circuitry, e.g., a field programmable gate array (“FPGA”) or an application-specific integrated circuit (“ASIC”). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can be performed by, and apparatus can also be implemented as, special purpose logic circuitry, e.g., a field programmable gate array (“FPGA”) or an application-specific integrated circuit (“ASIC”).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. A computer can be embedded in another device, e.g., a mobile telephone, a smart phone, a headset, a personal digital assistant (“PDA”), a mobile audio or video player, a game console, a Global Positioning System (“GPS”) receiver, or a portable storage device, e.g., a universal serial bus (“USB”) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a liquid crystal display (“LCD”), an organic light emitting diode (“OLED”) or other monitor, for displaying information to the user and a keyboard and a pointing device, e.g., a mouse or a trackball or a touchscreen, by which the user can provide input to the computer. Other kinds of devices can be used to provide for interaction with a user as well. For example, feedback provided to the user can be any form of sensory feedback, e.g., visual feedback, auditory feedback, or tactile feedback; and input from the user can be received in any form, including acoustic, speech, or tactile input. In some examples, a computer can interact with a user by sending documents to and receiving documents from a device that is used by the user; for example, by sending web pages to a web browser on a user’s device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., an Hypertext Markup Language (“HTML”) page, to a user device, e.g., for purposes of displaying data to and receiving user input from a user device, which acts as a client. Data generated at the user device, e.g., a result of user interaction with the user device, can be received from the user device at the server.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some instances be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the invention have been described. Other implementations are within the scope of the following claims. For example, the operations recited in the claims, described in the specification, or depicted in the figures can be performed in a different order and still achieve desirable results. In some implementations, multitasking and parallel processing may be advantageous.

1. A computer-implemented method, comprising:
detecting, by a device at a property, an object of interest;
determining, by the device, whether a first feature vector that likely represents the object of interest and was received from a different device is available;
in response to determining that the first feature vector that likely represents the object of interest and was received from the different device is available, obtaining, by the device, the first feature vector that likely represents the object of interest and was received from the different device;
performing, by the device, an analysis task for the object of interest at least using the first feature vector that likely represents the object of interest and was received from the different device; and
performing, by the device, an action using a result of the analysis task.

2. The method of claim 1, comprising:
generating, by the device, a second feature vector for the object of interest using sensor data captured by a sensor coupled to the device,
wherein performing the analysis task for the object of interest uses: (i) the second feature vector for the object of interest generated using the sensor data captured by the sensor coupled to the device; and (ii) the first feature vector that likely represents the object of interest and was received from the different device.

3. The method of claim 2, wherein performing the analysis task for the object of interest uses a combined feature vector generated using the first feature vector and the second feature vector.

4. The method of claim 2, wherein performing the analysis task for the object of interest comprises:
sequentially providing the first feature vector and the second feature vector as input to an artificial intelligence model to cause the artificial intelligence model to a) store in memory an intermediate value generated from a first input, and use the intermediate value to process a second input and b) generate an output for the analysis task; and
obtaining the output for the analysis task after the artificial intelligence model processes all of the input.

5. The method of claim 2, wherein the first feature vector and the second feature vector represent the object of interest from different perspectives.

6. The method of claim 2, wherein performing the analysis task for the object of interest comprises:
processing the first feature vector and the second feature vector using an artificial intelligence model trained to determine whether the first feature vector and the second feature vector likely represent a same object; and
obtaining the result of the analysis task indicating whether the first feature vector and the second feature vector likely represent the same object.

7. The method of claim 1, comprising receiving the first feature vector in response to a detection of an event by the different device.

8. The method of claim 1, comprising:
in response to the device detecting an event, requesting the first feature vector; and
in response to requesting the first feature vector, receiving the first feature vector.

9. The method of claim 1, wherein performing, by the device, the action using the result of the analysis task comprises:
determining, by the device, that the result of the analysis task is likely related to a monitoring system action; and
in response to determining that the result of the analysis task is likely related to the monitoring system action, sending, by the device, the result of the analysis task to a monitoring system.

10. The method of claim 1, wherein performing, by the device, the action using the result of the analysis task comprises:
determining, by the device, that the result of the analysis task is not likely related to a monitoring system action; and
in response to determining that the result of the analysis task is not likely related to the monitoring system action, deleting, by the device, the first feature vector from a memory of the device.

11. A system comprising one or more computers and one or more storage devices on which are stored instructions that are operable, when executed by the one or more computers, to cause the one or more computers to perform operations comprising:
detecting, by a device at a property, an object of interest;
determining, by the device, whether a first feature vector that likely represents the object of interest and was received from a different device is available;
in response to determining that the first feature vector that likely represents the object of interest and was received from the different device is available, obtaining, by the device, the first feature vector that likely represents the object of interest and was received from the different device;
performing, by the device, an analysis task for the object of interest at least using the first feature vector that likely represents the object of interest and was received from the different device; and
performing, by the device, an action using a result of the analysis task.

12. The system of claim 11, comprising:
generating, by the device, a second feature vector for the object of interest using sensor data captured by a sensor coupled to the device,
wherein performing the analysis task for the object of interest uses: (i) the second feature vector for the object of interest generated using the sensor data captured by the sensor coupled to the device; and (ii) the first feature vector that likely represents the object of interest and was received from the different device.

13. The system of claim 12, wherein performing the analysis task for the object of interest uses a combined feature vector generated using the first feature vector and the second feature vector.

14. The system of claim 12, wherein performing the analysis task for the object of interest comprises:
sequentially providing the first feature vector and the second feature vector as input to an artificial intelligence model to cause the artificial intelligence model to a) store in memory an intermediate value generated from a first input, and use the intermediate value to process a second input and b) generate an output for the analysis task; and
obtaining the output for the analysis task after the artificial intelligence model processes all of the input.

15. The system of claim 12, wherein the first feature vector and the second feature vector represent the object of interest from different perspectives.

16. The system of claim 12, wherein performing the analysis task for the object of interest comprises:
processing the first feature vector and the second feature vector using an artificial intelligence model trained to determine whether the first feature vector and the second feature vector likely represent a same object; and
obtaining the result of the analysis task indicating whether the first feature vector and the second feature vector likely represent the same object.

17. The system of claim 11, comprising receiving the first feature vector in response to a detection of an event by the different device.

18. The system of claim 11, comprising:
in response to the device detecting an event, requesting the first feature vector; and
in response to requesting the first feature vector, receiving the first feature vector.

19. The system of claim 11, wherein performing, by the device, the action using the result of the analysis task comprises:
determining, by the device, that the result of the analysis task is likely related to a monitoring system action; and
in response to determining that the result of the analysis task is likely related to the monitoring system action, sending, by the device, the result of the analysis task to a monitoring system.

20. One or more computer storage media encoded with instructions that, when executed by one or more computers, cause the one or more computers to perform operations comprising:
detecting, by a device at a property, an object of interest;
determining, by the device, whether a first feature vector that likely represents the object of interest and was received from a different device is available;
in response to determining that the first feature vector that likely represents the object of interest and was received from the different device is available, obtaining, by the device, the first feature vector that likely represents the object of interest and was received from the different device;
performing, by the device, an analysis task for the object of interest at least using the first feature vector that likely represents the object of interest and was received from the different device; and
performing, by the device, an action using a result of the analysis task.
